(19) United States
(12) Patent Application Publication
(10) Pub. No.: US 2016/0114529 A1
(43) Pub. Date: Apr. 28, 2016

(54) THREE-DIMENSIONAL OBJECT MANUFACTURING METHOD, THREE-DIMENSIONAL OBJECT MANUFACTURING DEVICE, AND THREE-DIMENSIONAL OBJECT

(71) Applicant: SEIKO EPSON CORPORATION, Tokyo (JP)

(72) Inventor: Shinichi Nakamura, Azumino-shi (JP)

(21) Appl. No.: 14/919,552

(22) Filed: Oct. 21, 2015

(30) Foreign Application Priority Data
Oct. 22, 2014 (JP) 2014-215126

(51) Int. Cl. B29C 67/00

(52) U.S. Cl. CPC B29C 67/0059; B29C 67/0085; B29K 2105/16

(57) ABSTRACT

A three-dimensional object manufacturing method for producing a three-dimensional object by laminating layers includes: ejecting a UV curable resin-containing curable ink to form a layer; irradiating the ejected curable ink with ultraviolet light; and heating the ejected curable ink. The heating heats the curable ink to at least a glass transition point of the UV curable resin.

### BACKGROUND

1. Technical Field

The present invention relates to a three-dimensional object manufacturing method, a three-dimensional object manufacturing device, and a three-dimensional object.

2. Related Art

Methods are known that form a three-dimensional object from a three-dimensional object model created by, for example, three-dimensional CAD software or the like.

One such method of forming a three-dimensional object is the lamination method (see, for example, JP-A-2000-280354). In the lamination method, a three-dimensional object model is typically divided into large numbers of two-dimensional cross section layers, and cross sections corresponding to these two-dimensional cross section layers are successively formed and laid down to build a three-dimensional object.

For instant formation of an object, the lamination method simply requires a model of the three-dimensional object to be produced. The method does not require fabricating a mold in advance of the production of an object, and enables forming a three-dimensional object both quickly and inexpensively. Because the method laminates sheet-like thin cross sections layer by layer, an object can be formed as an integral product, rather than a product made up of separate components, even when the object is a complicated object with, for example, an internal structure.

In methods of related art, a curable ink is ejected to form divided layers from three-dimensional data of a three-dimensional object, and these layers are laminated to form an object. A problem of forming layers of ejected curable ink, however, is that thickness variation occurs when there is, for example, variation in the ejection of the curable ink, cure shrinkage or the like. This lowers the dimensional accuracy of the finished three-dimensional object.

### SUMMARY

An advantage of some aspects of the invention is to provide a three-dimensional object manufacturing method and a three-dimensional object manufacturing device with which a three-dimensional object can be efficiently produced with high dimensional accuracy, and a three-dimensional object produced with high dimensional accuracy.

The and other advantages can be achieved with the following aspects of the invention.

A three-dimensional object manufacturing method according to an aspect of the invention is a three-dimensional object manufacturing method for producing a three-dimensional object by laminating layers, the method including: ejecting a UV curable resin-containing curable ink to form a layer; irradiating the ejected curable ink with ultraviolet light; and heating the ejected curable ink.

With this configuration, a three-dimensional object of high dimensional accuracy can be efficiency produced.

In the three-dimensional object manufacturing method of the aspect of the invention, it is preferable that the heating heats the curable ink to at least a glass transition point of the UV curable resin after the UV irradiation.

With this configuration, a three-dimensional object of high dimensional accuracy can be efficiency produced.

It is preferable that the three-dimensional object manufacturing method of the aspect of the invention further includes irradiating the ejected curable ink with ultraviolet light after the heating of the ejected curable ink.

With this configuration, the three-dimensional object can have high mechanical strength.

In the three-dimensional object manufacturing method of the aspect of the invention, it is preferable that in the ejecting, the curable ink is ejected onto a three-dimensional object composition layer formed with a three-dimensional object composition that contains particles and a binder resin.

With this configuration, a three-dimensional object of high dimensional accuracy can be efficiency produced.

In the three-dimensional object manufacturing method of the aspect of the invention, it is preferable that the particles are at least one selected from the group consisting of silica, calcium carbonate, alumina, titanium oxide, aluminum, titanium, iron, copper, magnesium, stainless steel, and maraging steel.

With this configuration, a three-dimensional object of high dimensional accuracy can be efficiency produced.

In the three-dimensional object manufacturing method of the aspect of the invention, it is preferable that the binder resin contains at least one selected from the group consisting of polyvinyl alcohol, polyvinyl pyrrolidone, sodium polyacrylate, ammonium polyacrylate, carboxymethyl cellulose, hydroxyethyl cellulose, polyethylene oxide, polyethylene glycol, polyacrylamide, polyethyleneimine, paraffin wax, low-molecular polyolefin wax, silicone-based wax, and microwax.

With this configuration, a three-dimensional object of high dimensional accuracy can be efficiency produced.

In the three-dimensional object manufacturing method of the aspect of the invention, it is preferable that the heating heats the curable ink to a temperature that is below a glass transition point of the binder resin.

With this configuration, a three-dimensional object of high dimensional accuracy can be efficiency produced.

A three-dimensional object manufacturing device according to another aspect of the invention is a three-dimensional object manufacturing device for producing a three-dimensional object by laminating layers, the device including: an object creating section where the three-dimensional object is created; an ejection unit that ejects a UV curable resin-containing curable ink to form an ink layer on the object creating section; a ultraviolet irradiation unit that irradiates the ejected curable ink with ultraviolet light; and a heating unit that heats the ejected curable ink, wherein the heating unit heats the curable ink to at least a glass transition temperature of the UV curable resin.

With this configuration, a three-dimensional object of high dimensional accuracy can be efficiency produced.

A three-dimensional object according to still another aspect of the invention is produced using the three-dimensional object manufacturing method of the aspect of the invention.

With this configuration, a three-dimensional object of high dimensional accuracy can be provided.

A three-dimensional object according to yet another aspect of the invention is produced using the three-dimensional object manufacturing device of the aspect of the invention.

With this configuration, a three-dimensional object of high dimensional accuracy can be provided.

### BRIEF DESCRIPTION OF THE DRAWINGS

The invention will be described with reference to the accompanying drawings, wherein like numbers reference like elements.

FIGS. 1A and 1B are diagrams representing a preferred embodiment of a three-dimensional object manufacturing device according to the invention, in which FIG. 1A is a side view, and FIG. 1B of a top view of the three-dimensional object manufacturing device.

### DESCRIPTION OF EXEMPLARY EMBODIMENTS

A preferred embodiment of the invention is described below in detail with reference to the accompanying drawings.

### 1. Three-Dimensional Object Manufacturing Device

A preferred embodiment of a three-dimensional object manufacturing device according to the invention is described below.

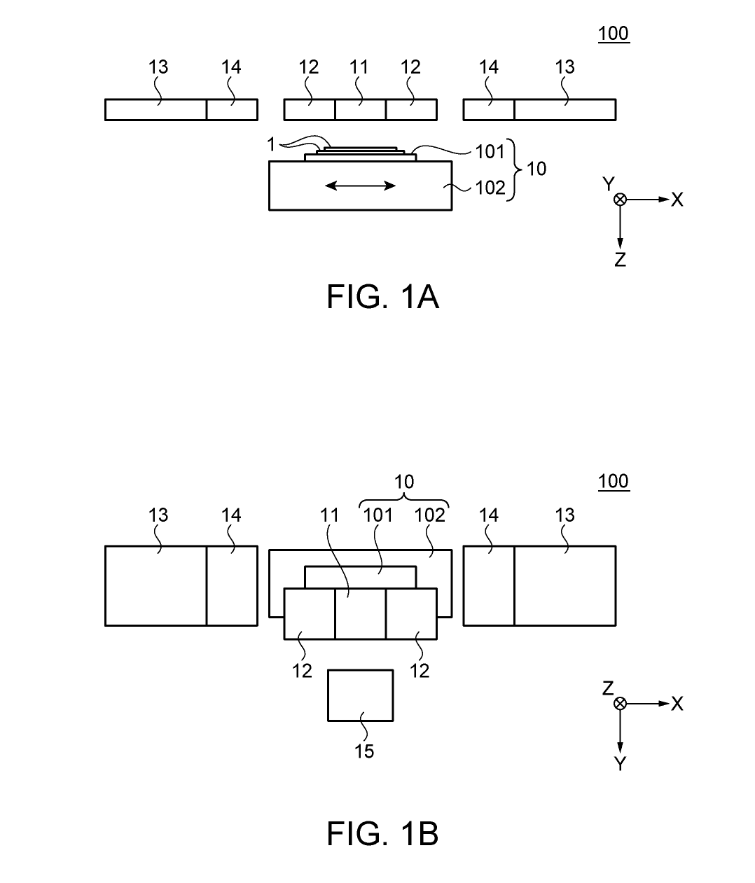

FIGS. 1A and 1B are diagrams representing a preferred embodiment of a three-dimensional object manufacturing device according to the invention, in which FIG. 1A is a side view, and FIG. 1B of a top view of the three-dimensional object manufacturing device.

A three-dimensional object manufacturing device 100 is a device that forms a layer 1 by ejecting a UV curable resin-containing curable ink, and laminates the layer 1 to produce a three-dimensional object.

As illustrated in FIGS. 1A and 1B, the three-dimensional object manufacturing device 100 includes an object creating section 10 where a three-dimensional object is created, an ejecting unit 11 that ejects a UV curable resin-containing curable ink onto the object creating section 10 to form a layer 1 on the object creating section 10, a first UV-irradiation unit 12 that irradiates the layer 1 with ultraviolet light, a heating unit 13 that heats the layer 1, and a second UV-irradiation unit 14 that irradiates the layer 1 with ultraviolet light after the layer 1 is heated.

The object creating section 10 has a work (object creating stage) 101 where the layer 1 is formed and laminated, and a work table 102.

The work table 102 is movable in X-axis direction and Z-axis direction, as depicted in the figures. The device is configured so that the work 101 moves in X-axis direction and Z-axis direction with the movement of the work table 102.

The surface of the work 101 is subjected to a liquid repellent treatment such as a fluorine treatment so as to reduce adhesion of the curable ink.

The ejecting unit 11 functions to move in Y-axis direction relative to the object creating section 10, and to eject the curable ink onto the work 101. The curable ink ejected on the work 101 forms the layer 1.

On the ejecting unit 11 is mounted a droplet ejection head that ejects the curable ink in droplets according to the inkjet scheme. The ejecting unit 11 also includes a curable ink feeding section (not illustrated). The droplet ejection head used in the present embodiment is a so-called piezo-driving head. In the present embodiment, the droplet ejection head of the ejecting unit 11 is a line head that includes a plurality of nozzles arrayed in Y-axis direction. As used herein, “line head” is a droplet ejection head in which a nozzle region formed along Y-axis direction orthogonal to X-axis direction is provided to enable full coverage of the work 101, and that is used for a three-dimensional object manufacturing device in which one of the ejecting unit 11 and the object creating section 10 is moved to form the layer 1 while fixing the other. The Y-axis nozzle region of the line head is not necessarily required to enable full coverage along the Y-axis direction of all types of object creating section 10 accommodated by the three-dimensional object manufacturing device.

The first UV-irradiation unit 12 functions to irradiate the layer 1 with ultraviolet light, and to cure the UV curable resin in the layer 1.

The first UV-irradiation unit 12 is provided at the both ends of the ejecting unit 11 in X-axis direction.

In the present embodiment, for example, the ejecting unit 11 ejects the curable ink on the work 101, and the first UV-irradiation unit 12 on the left-hand side of FIGS. 1A and 1B irradiates UV light on the layer 1 while the object creating section 10 moves to the right in FIGS. 1A and 1B. On the other hand, the ejecting unit 11 ejects the curable ink on the work 101, and the first UV-irradiation unit 12 on the right-hand side of FIGS. 1A and 1B irradiates UV light on the layer 1 while the object creating section 10 moves to the left in FIGS. 1A and 1B.

The heating unit 13 is configured to heat the layer 1 irradiated with UV light by the first UV-irradiation unit 12.

In the present embodiment, the heating unit 13 is installed adjacent to each first UV-irradiation unit 12 in X-axis direction. The device is configured so that the heating unit 13 heats the layer 1 as the object creating section 10 moves in X-axis direction.

The heating unit 13 heats the layer 1 (curable ink) to at least the glass transition point of the UV curable resin. This softens the UV curable resin in the layer 1, and eliminates irregularities (thickness variation) due to factors such as variation in the ejection of the curable ink, and cure shrinkage. Specifically, the surface of the layer 1 becomes leveled (planarized) as the UV curable resin in the layer 1 softens. The layer 1 can thus have a uniform thickness, and a three-dimensional object of high dimensional accuracy can be produced.

The second UV-irradiation unit 14 is provided adjacent each heating unit 13, on the side of the object creating section 10.

The second UV-irradiation unit 14 functions to irradiate the layer 1 with UV light after the layer 1 is heat treated with the heating unit 13. The UV irradiation of the layer 1 after heat treatment sufficiently cures the UV curable resin in the layer 1, and the mechanical strength of the finished three-dimensional object can further improve.

The three-dimensional object manufacturing device 100 has a maintenance unit 15 provided on the side of the object creating section 10 in Y-axis direction, as shown in FIG. 1B.

The maintenance unit 15 is provided for maintenance of the droplet ejection head of the ejecting unit 11.

The layer 1 can have small thickness variation in the three-dimensional object manufacturing device 100 of the configuration described above, and a three-dimensional object of high dimensional accuracy can be produced.

### 2. Three-Dimensional Object Manufacturing Method

A three-dimensional object manufacturing method according to the invention is described below.

A three-dimensional object manufacturing method of the present embodiment is a method that laminates a layer 1 to manufacture a three-dimensional object, and includes ejecting a UV curable resin-containing curable ink to form a layer 1 (ink ejection step), irradiating the layer 1 with ultraviolet light (first UV irradiation step), heating the layer 1 (heating step), and irradiating the layer 1 with ultraviolet light after the layer 1 is heated (second UV irradiation step).

The following describes the method using the three-dimensional object manufacturing device 100 above as an example.

First, the object creating section 10 moves to the curable ink ejection region of the ejecting unit 11.

The ejecting unit 11 imparts a curable ink to the object creating section 10 to form the layer 1 (ink ejection step).

The first UV-irradiation unit 12 then irradiates the layer 1 with ultraviolet light (first UV irradiation step). Examples of the first UV-irradiation unit 12 include high-pressure mercury UV lamps, metal halide UV lamps, and LED UV irradiators.

The heating unit 13 heats the layer 1 to at least the glass transition point of the UV curable resin (heating step). Examples of the heating unit 13 include infrared heaters (halogen heaters, sheath heaters, and ceramic heaters), and heated air heaters.

Heating the layer 1 to at least the glass transition point of the UV curable resin softens the UV curable resin in the layer 1, and eliminates irregularities (thickness variation) due to factors such as variation in the ejection of the curable ink, and cure shrinkage. Specifically, the surface of the layer 1 becomes leveled (planarized) as the UV curable resin in the layer 1 softens. The layer 1 can thus have a uniform thickness, and a three-dimensional object of high dimensional accuracy can be produced.

Preferably, the heating step is performed after the UV irradiation step, as in the present embodiment. In this way, a three-dimensional object of high dimensional accuracy can be produced even more effectively.

The second UV-irradiation unit 14 irradiates the layer 1 with UV light after the heat treatment in the heating step (second UV irradiation step). With the second UV irradiation step, the UV curable resin in the layer 1 can be cured more reliably with the maintained leveled (planarized) state achieved in the heating step. The layer 1 can thus have a uniform thickness, and a three-dimensional object with excellent mechanical strength can be obtained. Examples of the second UV-irradiation unit 14 include high pressure mercury UV lamps, metal halide UV lamps, and LED UV irradiators.

This series of steps is repeated, and a three-dimensional object as a laminate of a plurality of layers 1 is obtained.

The foregoing described the case where the first UV irradiation step, the heating step, and the second UV irradiation step are performed layer by layer. However, for example, the first UV irradiation step, the heating step, and the second UV irradiation step may be performed after laminating a plurality of layers.

The quantity of UV irradiation in the first UV irradiation step is preferably smaller than the quantity of UV irradiation in the second UV irradiation step. In this way, the surface irregularities of the layer 1 can be further reduced, and the layer 1 can be formed more uniformly.

When UV light is irradiated layer by layer, it is preferable to irradiate at least 100 mJ of UV light in the first UV irradiation step.

When UV light is irradiated layer by layer, it is preferable to irradiate at least 200 mJ of UV light in the second UV irradiation step.

When UV light is irradiated on a plurality of layers, it is preferable to irradiate 300 mJ to 350 mJ of UV light in the first UV irradiation step.

When UV light is irradiated on a plurality of layers, it is preferable to irradiate 350 mJ to 400 mJ of UV light in the second UV irradiation step.

The foregoing described the case where the layer 1 is formed solely with the curable ink. It is possible, however, to form the layer 1 by ejecting the curable ink onto a three-dimensional object composition layer formed using a three-dimensional object composition containing particles, a binder resin, and a solvent. In this case, the curable ink is ejected onto the three-dimensional object composition layer after the solvent contained in the three-dimensional object composition is removed with the heating unit 13. The heating unit 13 then heats the curable ink ejected onto the three-dimensional object composition layer. The applied heat moves the curable ink inside the three-dimensional object composition layer, and makes the layer 1 uniform. The layer 1 of sufficiently uniform thickness also can be easily obtained in this manner, and a three-dimensional object of high dimensional accuracy can be produced.

When using the three-dimensional object composition, the curable ink heating temperature in the heating step is preferably less than the glass transition point of the binder resin. In this way, the UV curable resin can be softened while maintaining the bondability of the particles in the heating step, and a three-dimensional object of even higher dimensional accuracy can be produced. The mechanical strength of the finished three-dimensional object also can improve.

### 3. Curable Ink

The curable ink contains at least a UV curable resin.

UV Curable Resin

The UV curable resin (polymerizable compound) is preferably one that produces polymer by undergoing addition polymerization or ring-opening polymerization with radicals, cations, or other such species that generate from a photopolymerization initiator upon UV irradiation. The addition polymerization may be of a form such as radical, cation, anion, metathesis, and coordination polymerization. The ring-opening polymerization may be of a form such as cation, anion, radical, metathesis, and coordination polymerization.

Examples of addition polymerizable compounds include compounds having at least one ethylenic unsaturated double bond and the like. Preferred as addition polymerizable compounds are compounds having at least one, preferably two or more terminal ethylenic unsaturated bonds.

The ethylenic unsaturated polymerizable compounds are compounds having a chemical form of a monofunctional polymerizable compound, a multifunctional polymerizable compound, or a mixture of these. Examples of the monofunctional polymerizable compound include unsaturated carboxylic acids (for example, such as acrylic acid, methacrylic acid, itaconic acid, crotonic acid, isocrotonic acid, and maleic acid), and esters and amides thereof. Examples of the multifunctional polymerizable compound include esters of unsaturated carboxylic acids and aliphatic polyalcohol compounds, and amides of unsaturated carboxylic acids and aliphatic polyamine compounds.

It is also possible to use addition reaction products of unsaturated carboxylic acid esters or amides having a nucleophilic substituent such as a hydroxyl group, an amino group, and a mercapto group with isocyanates and epoxys, or dehydrocondensation reaction products with carboxylic acids. Also usable are addition reaction products of unsaturated carboxylic acid esters or amides having an electrophilic substituent such as an isocyanate group and an epoxy group with alcohols, amines, and thiols. It is also possible to use substitution reaction products of unsaturated carboxylic acid esters or amides having a leaving substituent such as a halogen group and a tosyloxy group with alcohols, amines, or thiols.

Specifically, typical examples of radically polymerizable compounds as esters of unsaturated carboxylic acids and aliphatic polyalcohol compounds include (meth)acrylic acid esters, including monofunctional and multifunctional forms thereof.

Examples of monofunctional (meth)acrylates include phenoxyethyl(meth)acrylate, phenyloxyethyl(meth)acrylate, cyclohexyl(meth)acrylate, ethyl(meth)acrylate, methyl(meth)acrylate, isobornyl(meth)acrylate, tetrahydrofurfuryl(meth)acrylate, and 4-hydroxybutyl(meth)acrylate.

Specific examples of bifunctional (meth)acrylates include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, dipentaerythritol di(meth)acrylate, (meth)acrylic acid-2-(2-vinyloxyethoxy)ethyl, dipropylene glycol diacrylate, and tripropylene glycol diacrylate.

Specific examples of trifunctional (meth)acrylates include trimethylolpropane tri(meth)acrylate, trimethylolethane tri(meth)acrylate, alkylene oxide modified tri(meth)acrylate of trimethylolpropane, pentaerythritol tri(meth)acrylate, dipentaerythritol tri(meth)acrylate, trimethylolpropane tri((meth)acryloyloxypropyl)ether, isocyanuric acid alkylene oxide modified tri(meth)acrylate, propionic acid dipentaerythritol tri(meth)acrylate, tri((meth)acryloyloxyethyl)isocyanurate, hydroxypivalaldehyde modified dimethylolpropane tri(meth)acrylate, and sorbitol tri(meth)acrylate.

Specific examples of tetrafunctional (meth) acrylates include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Specific examples of pentafunctional (meth)acrylates include sorbitol penta(meth)acrylate, and dipentaerythritol penta(meth)acrylate.

Specific examples of hexafunctional (meth)acrylates include dipentaerythritol hexa(meth)acrylate, sorbitol hexa(meth)acrylate, alkylene oxide modified hexa(meth)acrylate of phosphazene, and caprolactone modified dipentaerythritol hexa(meth)acrylate.

Examples of polymerizable compounds other than (meth)acrylates include itaconic acid esters, crotonic acid esters, isocrotonic acid esters, and maleic acid esters.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

Examples of isocrotonic acid esters include ethylene glycol diisocrotonate, pentaerythritol diisocrotonate, and sorbitol tetraisocrotonate.

Examples of maleic acid esters include ethylene glycol dimalate, triethylene glycol dimalate, pentaerythritol dimalate, and sorbitol tetramalate.

Examples of other esters include aliphatic alcohol esters, such as those described in JP-B-46-27926, JP-B-51-47334, and JP-A-57-196231, esters with aromatic skeletons, such as those described in JP-A-59-5240, JP-A-59-5241, and JP-A-2-226149, and esters containing an amino group, such as those described in JP-A-1-165613.

Specific examples of monomers of amides of unsaturated carboxylic acids and aliphatic polyamine compounds include methylene bis-acrylamide, methylene bis-methacrylamide, 1,6-hexamethylene bis-acrylamide, 1,6-hexamethylene bis-methacrylamide, diethylenetriamine trisacrylamide, xylylene bisacrylamide, and xylylene bismethacrylamide.

Examples of other preferred amide monomers include compounds having a cyclohexylene structure, such as those described in JP-B-54-21726.

Also preferred are urethane-based addition polymerizable compounds produced through addition reaction of isocyanate and hydroxyl group. Specific examples of such compounds include vinyl urethane compounds containing two or more polymerizable vinyl groups per molecule produced by addition of a hydroxyl-containing vinyl monomer of the formula (1) below to a polyisocyanate compound having two or more isocyanate groups per molecule, for example, such as those described in JP-B-48-41708.

CH₂═C(R1)COOCH₂CH(R2)OH (1)

(In the formula (1), R1 and R2 each independently represent H or CH₃.)

In the embodiment of the invention, cationic ring-opening polymerizable compounds having one or more cyclic ether groups such as an epoxy group and an oxetane group within the molecule may preferably be used as the UV curable resin (polymerizable compound).

Examples of such cationic polymerizable compounds include curable compounds containing a ring-opening polymerizable group, particularly preferably heterocyclic group-containing curable compounds. Examples of such curable compounds include cyclic imino ethers (such as epoxy derivatives, oxetane derivatives, tetrahydrofuran derivatives, cyclic lactone derivatives, cyclic carbonate derivatives, and oxazoline derivatives), and vinyl ethers. Preferred are epoxy derivatives, oxetane derivatives, and vinyl ethers.

Preferred examples of the epoxy derivatives include monofunctional glycidyl ethers, multifunctional glycidyl ethers, monofunctional alicyclic epoxys, and multifunctional alicyclic epoxys.

Specific examples of glycidyl ether compounds include diglycidyl ethers (for example, such as ethylene glycol diglycidyl ether, and bisphenol A diglycidyl ether), tetrafunctional and higher functional glycidyl ethers (for example, such as trimethylolethane triglycidyl ether, trimethylolpropane triglycidyl ether, glycerol triglycidyl ether, and triglycidyl trishydroxyethyl isocyanurate), tetrafunctional and higher functional glycidyl ethers (for example, such as sorbitol tetraglycidyl ether, pentaerythritol tetraglycidyl ether, polyglycidyl ether of cresol novolac resin, polyglycidyl ether of phenol novolac resin, alicyclic epoxys, and oxetanes.

Alicyclic epoxy derivatives may preferably be used as the polymerizable compounds. Here, “alicyclic epoxy group” means a partial structure obtained after the epoxylation of a double bond in cycloalkene rings such as in cyclopentene groups and cyclohexene groups with a suitable oxidizing agent such as hydrogen peroxide, and peracid.

Preferred as the alicyclic epoxy compounds are multifunctional alicyclic epoxys having two or more cyclohexene oxide groups or cyclopentene oxide groups per molecule. Specific examples of such alicyclic epoxy compounds include 4-vinylcyclohexenedioxide, (3,4-epoxycyclohexyl)methyl-3,4-epoxycyclohexylcarboxylate, di(3,4-epoxycyclohexyl)adipate, di(3,4-epoxycyclohexylmethyl)adipate, bis(2,3-epoxycyclopentyl)ether, di(2,3-epoxy-6-methylcyclohexylmethyl)adipate, and dicyclopentadienedioxide.

Common glycidyl compounds having epoxy groups with no alicyclic structure within the molecule may be used alone or in combination with the alicyclic epoxy compounds.

Examples of such common glycidyl compounds include glycidyl ether compounds and glycidyl ester compounds. Preferably, the glycidyl compounds are used with glycidyl ether compounds.

Specific examples of the glycidyl ether compounds include aromatic glycidyl ether compounds such as 1,3-bis(2,3-epoxypropyloxy)benzene, bisphenol A-type epoxy resin, bisphenol F-type epoxy resin, phenol novolac-type epoxy resin, cresol novolac-type epoxy resin, and trisphenol methane epoxy resin; and aliphatic glycidyl ether compounds such as 1,4-butanediol glycidyl ether, glycerol triglycidyl ether, propylene glycol diglycidyl ether, and trimethylolpropane triglycidyl ether. Examples of the glycidyl esters include glycidyl esters of linolenic acid dimers.

Compounds having an oxetanyl group (4-membered cyclic ether) may be used as the polymerizable compounds (hereinafter, simply “oxetane compounds”). Oxetanyl-containing compounds are compounds having one or more oxetanyl groups within the molecule.

The content of the UV curable resin in the curable ink is preferably 80 mass % to 97 mass %, more preferably 85 mass % to 95 mass %.

In this way, the mechanical strength of the finished three-dimensional object can be particularly improved. The productivity of the three-dimensional object can also greatly improve.

### Other Components

The curable ink may contain other components. Examples of such components include various colorants such as pigments and dyes; dispersants; surfactants; polymerization initiators; polymerization promoters; solvents; permeation promoters; wetting agents (moisturizers); fixing agents; mildew-proofing agents; preservatives; antioxidants; UV absorbers; chelating agents; pH adjusters; thickeners; fillers; aggregation preventing agents; and defoaming agents.

With the curable ink containing a colorant, a three-dimensional object with the color of the colorant can be obtained.

Particularly, with a colorant containing a pigment, the curable ink and the three-dimensional object can have desirable lightfastness. The pigment may be an inorganic pigment or an organic pigment.

Examples of inorganic pigments include carbon blacks (C.I. pigment black 7; e.g., furnace black, lamp black, acetylene black, and channel black), iron oxide, and titanium oxide. These may be used either alone or in a combination of two or more.

Preferred as the inorganic pigment is titanium oxide for its ability to impart a desirable white color.

Examples of the organic pigments include azo pigments such as insoluble azo pigments, condensed azo pigments, azo lakes, and chelate azo pigments; polycyclic pigments such as phthalocyanine pigments, perylene and perinone pigments, anthraquinone pigments, quinacridone pigments, dioxane pigments, thioindigo pigments, isoindolinone pigments, and quinophthalone pigments; dye chelates (for example, such as basic dye chelate, and acidic dye chelate); dye lakes (basic dye lake, acidic dye lake); nitro pigments; nitroso pigments; aniline black; and daylight fluorescent pigments. These may be used either alone or in a combination of two or more.

When the curable ink contains a pigment, the pigment has an average particle size of preferably 300 nm or less, more preferably 50 nm to 250 nm. In this way, the ejection stability of the curable ink, and the dispersion stability of the pigment in the curable ink can greatly improve, and an excellent image quality can be obtained.

Examples of the dye include acidic dyes, direct dyes, reactive dyes, and basic dyes. These may be used either alone or in a combination of two or more.

When the curable ink contains a colorant, the colorant content in the curable ink is preferably 1 mass % to mass %. In this way, excellent hiding and color reproducibility can be obtained.

When the curable ink contains titanium oxide as the colorant, the titanium oxide content in the curable ink is preferably 12 mass % to 18 mass %, more preferably 14 mass % to 16 mass %. In this way, excellent hiding can be obtained.

A curable ink containing a pigment can have more desirable pigment dispersibility when it further contains a dispersant. In this case, a partial decrease of mechanical strength due to uneven pigment distribution can be reduced even more effectively.

The dispersant is not particularly limited, and, for example, dispersants, such as polymer dispersants, commonly used for the preparation of pigment dispersions may be used. Specific examples of such polymer dispersants include polymer dispersants of primarily at least one selected from polyoxyalkylene polyalkylene polyamine, vinyl polymers and copolymers, acrylic polymers and copolymers, polyester, polyamide, polyimide, polyurethane, amino polymers, silicon-containing polymer, sulfur-containing polymer, fluorine-containing polymer, and epoxy resin.

With the curable ink containing a surfactant, the three-dimensional object can have more desirable abrasion resistance. The surfactant is not particularly limited, and, for example, silicone-based surfactants such as polyester-modified silicone, and polyether modified silicone may be used. Preferred are polyether modified polydimethylsiloxane, and polyester modified polydimethylsiloxane.

The curable ink may contain a solvent. In this way, the viscosity of the curable ink can be adjusted more desirably, and the curable ink can have excellent ejection stability in inkjet applications, even when the curable ink contains a high viscosity component.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetyl acetone; and alcohols such as ethanol, propanol, and butanol. These may be used either alone or in a combination of two or more.

The viscosity of the curable ink is preferably 10 mPa·s to 25 mPa·s, more preferably 15 mPa·s to 20 mPa·s. In this way, the ink can have excellent ejection stability in inkjet applications. As used herein, “viscosity” is a measured value obtained with an E-type viscometer (Tokyo Keiki product VISCONIC ELD) at 25° C.

More than one curable ink may be used for the production of a three-dimensional object.

For example, a curable ink containing a colorant (color ink), and a curable ink containing no colorant (clear ink) may be used. As an example, the colorant-containing curable ink may be used in regions that affect the color appearing in the three-dimensional object, whereas the colorant-free curable ink may be used in regions that do not affect the color appearing in the three-dimensional object. It is also possible to use more than one curable ink in such a manner that the outer surface of the region formed with the colorant-containing curable ink is coated with the colorant-free curable ink (coating layer) in the finished three-dimensional object.

It is also possible to use, for example, a plurality of colorant-containing curable inks of different compositions. In this way, the expressible color reproduction range can be widened with different combinations of the curable inks.

When using a plurality of curable inks, it is preferable to use at least curable inks of blue-purple (cyan), red-purple (magenta), and yellow. In this way, the expressible color reproduction range can be further widened with different combinations of the curable inks.

The following effect can be obtained using a white curable ink with curable inks of other colors, for example. Specifically, the finished three-dimensional object can have a first region where the white curable ink is imparted, and regions of non-white, color curable inks overlying the first region on the outer surface thereof. In this way, the first region with the imparted white curable ink can provide hiding to further improve the color fidelity of the three-dimensional object.

### 4. Three-Dimensional Object Composition

The three-dimensional object composition is described below in detail.

The three-dimensional object composition contains particles, a binder resin, and a solvent.

The following specifically describes each component.

### Particles

Examples of the particle constituent materials include inorganic materials, organic materials, and combinations of these.

Examples of particle-forming inorganic materials include various metals and metallic compounds. Examples of the metallic compounds include aluminum, titanium, iron, copper, magnesium, stainless steel, maraging steel; various metal oxides such as silica, alumina, titanium oxide, zinc oxide, zircon oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbides such as silicon carbide, and titanium carbide; various metal sulfides such as zinc sulfide; various metal carbonates such as calcium carbonate, and magnesium carbonate; various metal sulfates such as calcium sulfate, and magnesium sulfate; various metal silicates such as calcium silicate, and magnesium silicate; various metal phosphates such as calcium phosphate; various metal borates such as aluminum borate, and magnesium borate; and combinations of these compounds.

Examples of particle-forming organic materials include synthetic resins, and natural polymers. Specific examples include polyethylene resin; polypropylene; polyethylene oxide; polypropylene oxide; polyethyleneimine; polystyrene; polyurethane; polyurea; polyester; silicone resin; acryl silicone resin; polymers, such as polymethylmethacrylate, containing (meth)acrylic acid esters as the constituent monomer; crosslinked polymers, such as a methyl methacrylate crosslinked polymer, containing (meth) acrylic acid esters as the constituent monomer (such as ethylene acrylic acid copolymerized resin); polyamide resins such as nylon 12, nylon 6, and copolymerized nylons; polyimide; carboxymethylcellulose; gelatin; starch; chitin; and chitosan.

The particles are preferably of inorganic materials, more preferably of metal oxides, further preferably of at least one selected from the group consisting of silica, calcium carbonate, alumina, and titanium oxide. In this way, the three-dimensional object can have excellent properties, including excellent mechanical strength and excellent lightfastness. Such particles are also advantageous in terms of forming layers of high thickness uniformity, and the three-dimensional object can have excellent productivity and dimensional accuracy.

The silica may be preferably selected from commercially available products.

The average particle size of the particles is not particularly limited, and is preferably 1 μm to 25 μm, more preferably 1 μm to 15 μm. In this way, the three-dimensional object can have excellent mechanical strength, and inadvertent formation of irregularities or other defects in the product three-dimensional object can be effectively prevented to greatly improve the dimensional accuracy of the three-dimensional object. It is also possible to greatly improve the fluidity of the three-dimensional object powder, and the fluidity of the three-dimensional object composition containing the three-dimensional object powder, and thus the productivity of the three-dimensional object. As used herein, “average particle size” refers to volume average particle size, and it can be determined, for example, by measuring a sample through 50-μm apertures with a Coulter counter particle size distribution measurement device (COULTER ELECTRONICS INC product TA-II) after adding and dispersing the sample in methanol for 3 minutes with a ultrasonic disperser.

The Dmax of the particles is preferably 3 μm to 40 μm, more preferably 5 μm to 30 μm. In this way, the three-dimensional object can have excellent mechanical strength, and inadvertent formation of irregularities or other defects in the product three-dimensional object can be effectively prevented to greatly improve the dimensional accuracy of the three-dimensional object. It is also possible to greatly improve the fluidity of the three-dimensional object powder, and the fluidity of the three-dimensional object composition containing the three-dimensional object powder, and thus the productivity of the three-dimensional object. Scattering of light by the particles at the surface of the product three-dimensional object also can be effectively prevented.

The particles may have any shape, and are preferably spherical. In this way, it is possible to greatly improve the fluidity of the three-dimensional object powder, and the fluidity of the three-dimensional object composition containing the three-dimensional object powder, and thus the productivity of the three-dimensional object. Inadvertent formation of irregularities or other defects in the product three-dimensional object also can be effectively prevented to greatly improve the dimensional accuracy of the three-dimensional object. Scattering of light by the particles at the surface of the product three-dimensional object also can be effectively prevented.

The content of the three-dimensional object powder in the three-dimensional object composition is preferably 10 mass % to 90 mass %, more preferably 15 mass % to 58 mass %. The particles may be porous with a bulk density of typically about 0.1 g/cm³ to 1.0 g/cm³. Preferably, the particles are porous powders with a bulk density of 0.15 g/cm³ to 0.5 g/cm³. In this way, the three-dimensional object composition can have sufficiently high fluidity, and the mechanical strength of the finished three-dimensional object can be greatly improved.

### Binder Resin

The three-dimensional object composition contains a binder resin, in addition to the particles. With the binder resin, the particles can bind to each other (temporary fixing), and, for example, inadvertent scattering of particles can be effectively prevented. This makes it possible to improve the operator safety, and the dimensional accuracy of the product three-dimensional object.

The binder resin is preferably at least partially soluble in water. For example, the binder resin has a water solubility (mass that can dissolve in 100 g of water) of preferably at least 5 [g/100 g of water], more preferably at least 10 [g/100 g of water] at 25° C. This makes it easier to remove unbound particles.

The binder resin in the three-dimensional object composition is preferably in a liquid state (for example, a dissolved or a melted state) at least in the layer forming step. In this way, the thickness uniformity of the layer 1 formed with the three-dimensional object composition can be improved both easily and reliably.

The binder resin used is preferably one that contains at least one selected from the group consisting of polyvinyl alcohol, polyvinyl pyrrolidone, sodium polyacrylate, ammonium polyacrylate, carboxymethyl cellulose, hydroxyethyl cellulose, polyethylene oxide, polyethylene glycol, polyacrylamide, and polyethyleneimine. In this way, the affinity between the binder resin and the particles can be greatly improved. It is also possible to use, for example, a paraffin wax, a low-molecular polyolefin wax, a silicone-based wax, and a microwax (microcrystalline wax).

The content of the binder resin in the three-dimensional object composition is preferably 15 volume % or less, more preferably 2 volume % to 5 volume % with respect to the bulk volume of the particles. In this way, a wide space can be provided for the entry of the curable ink while allowing the binder resin to sufficiently exhibit its functions, and the three-dimensional object can have excellent mechanical strength.

### Solvent

The three-dimensional object composition may contain a solvent, in addition to the binder resin and the particles.

With the solvent, it is possible to greatly improve the fluidity of the three-dimensional object composition, and the productivity of the three-dimensional object.

The solvent forming the three-dimensional object composition is preferably water, and/or a liquid having good compatibility with water, more preferably primarily water. The solvent has a water content of preferably 70 wt % or more, more preferably 90 wt % or more. In this way, the binder resin can be reliably dissolved, and the fluidity of the three-dimensional object composition, and the composition uniformity of the layer 1 formed with the three-dimensional object composition can greatly improve. Water can be easily removed after the formation of the layer 1, and is unlikely to cause adverse effects even when it remains in the three-dimensional object. Water is also advantageous from the viewpoints of safety against human body, and environmental friendliness.

The content of the solvent in the three-dimensional object composition is preferably 5 mass % to 75 mass %, more preferably 35 mass % to 70 mass %. In this way, the effects exhibited by containing the solvent become more prominent, and the solvent can be easily removed in a short time period in the manufacturing process of the three-dimensional object to improve the productivity of the three-dimensional object.

When the solvent contained in the three-dimensional object composition is water, the water content in the three-dimensional object composition is preferably 20 mass % to 73 mass %, more preferably 50 mass % to 70 mass %. In this way, the foregoing effects can be exhibited more prominently.

### Other Components

The three-dimensional object composition may contain other components. Examples of such components include polymerization initiators, polymerization promoters, permeation promoters, wetting agents (moisturizers), fixing agents, mildew-proofing agents, preservatives, antioxidants, UV absorbers, chelating agents, and pH adjusters.

### 5. Three-Dimensional Object

The three-dimensional object of the embodiment of the invention may be produced using the manufacturing method and the manufacturing device described above. The three-dimensional object produced can have high dimensional accuracy.

Use of the three-dimensional object of the embodiment of the invention is not particularly limited. Applicable areas include, for example, ornaments and exhibits such as dolls and figures, and medical equipment such as implants.

The three-dimensional object of the embodiment of the invention may be any of prototypes, mass products, and made-to-order products.

The three-dimensional object of the embodiment of the invention also may be used as models (for example, models of vehicles and vessels such as automobiles, motorcycles, ships, airplanes; architectural structures; living objects such as animals and plants; natural objects (non-living objects) such as stones; and various food products).

While there have been described a preferred embodiment of the invention, it will be understood that the invention is not limited by the embodiment above.

For example, the three-dimensional object manufacturing method of the embodiment of the invention may include a pre-processing step, an intermediate processing step, and a post-processing step, as required.

The pre-processing step may be, for example, a stage cleaning step.

The post-processing step may be, for example, a washing step, a binder resin removing step by water or heat, a shape adjusting step such as by removing burrs, or additional curing for improving the extent of curing of the curable resin.

The invention is also applicable to a powder lamination method (specifically, a method in which a layer is formed with a powder, and a series of procedures including imparting a curable ink to a predetermined location of the layer and forming a cured portion is repeated to obtain a three-dimensional object as a laminate of a plurality of layers having cured portions.

The entire disclosure of Japanese Patent Application No.2014-215126, filed Oct. 22, 2014 is expressly incorporated by reference herein.

What is claimed is:

1. A three-dimensional object manufacturing method for producing a three-dimensional object by laminating layers,
the method comprising:
ejecting a UV curable resin-containing curable ink to form a layer;
irradiating the ejected curable ink with ultraviolet light; and
heating the ejected curable ink.

2. The method according to claim 1, wherein the heating heats the curable ink to at least a glass transition point of the UV curable resin after the UV irradiation.

3. The method according to claim 1, further comprising irradiating the ejected curable ink with ultraviolet light after the heating of the ejected curable ink.

4. The method according to claim 1, wherein in the ejecting, the curable ink is ejected onto a three-dimensional object composition layer formed with a three-dimensional object composition that contains particles and a binder resin.

5. The method according to claim 4, wherein the particles are at least one selected from the group consisting of silica, calcium carbonate, alumina, titanium oxide, aluminum, titanium, iron, copper, magnesium, stainless steel, and maraging steel.

6. The method according to claim 4, wherein the binder resin contains at least one selected from the group consisting of polyvinyl alcohol, polyvinyl pyrrolidone, sodium polyacrylate, ammonium polyacrylate, carboxymethyl cellulose, hydroxyethyl cellulose, polyethylene oxide, polyethylene glycol, polyacrylamide, polyethyleneimine, paraffin wax, low-molecular polyolefin wax, silicone-based wax, and microwax.

7. The method according to claim 4, wherein the heating heats the curable ink to a temperature that is below a glass transition point of the binder resin.

8. A three-dimensional object manufacturing device for producing a three-dimensional object by laminating layers,
the device comprising:
an object creating section where the three-dimensional object is created;
an ejection unit that ejects a UV curable resin-containing curable ink to form an ink layer on the object creating section;
a ultraviolet irradiation unit that irradiates the ejected curable ink with ultraviolet light; and
a heating unit that heats the ejected curable ink,
wherein the heating unit heats the curable ink to at least a glass transition temperature of the UV curable resin.

9. A three-dimensional object produced using the three-dimensional object manufacturing method of claim 1.

10. A three-dimensional object produced using the three-dimensional object manufacturing method of claim 2.

11. A three-dimensional object produced using the three-dimensional object manufacturing method of claim 3.

12. A three-dimensional object produced using the three-dimensional object manufacturing method of claim 4.

13. A three-dimensional object produced using the three-dimensional object manufacturing method of claim 5.

14. A three-dimensional object produced using the three-dimensional object manufacturing method of claim 6.

15. A three-dimensional object produced using the three-dimensional object manufacturing method of claim 7.

16. A three-dimensional object produced using the three-dimensional object manufacturing device of claim 8.
